(19) United States
(12) Patent Application Publication
(10) Pub. No.: US 2008/0293437 A1
(43) Pub. Date: Nov. 27, 2008

(54) REDUCING PAGING RESPONSE TIME IN A WIRELESS COMMUNICATION SYSTEM

(75) Inventors: Murali Ranganathan, Phoenix, AZ (US); Steven J. Lambert, Mount Prospect, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/751,650

(22) Filed: May 22, 2007

(51) Int. Cl. H04Q 7/20

(52) U.S. Cl. 455/458

(57) ABSTRACT

A method and wireless communication system to reduce paging response time for a target mobile station (MS) operable using slotted and unslotted modes in multiple paging location areas of the system includes a first step 300 of receiving a paging request message for the MS. A next step 302 includes setting a paging indicator for the MS. A next step 304 includes broadcasting the paging indicator to all paging location areas of the system. A next step 306 includes operating the MS in unslotted mode upon recognition of the paging indicator. A next step 308 includes paging the MS in a last known location and failing to establish contact with the MS. A next step 310 includes re-paging the MS in selected location areas of the system based on a probability based search algorithm. A next step 312 includes operating the MS in slotted mode again upon successful call processing.

### FIELD OF THE INVENTION

The present invention relates generally to wireless communication systems and, in particular, to paging a mobile station in a wireless communication system.

### BACKGROUND OF THE INVENTION

Paging response time is a common problem in wireless communication systems where the location of a mobile station is unknown over a wide coverage area. In addition, a large amount of congestion is involved in sending paging requests to multiple areas in an attempt to locate a mobile station. These problems present the disadvantage of decreasing the paging success rate and degrading overall performance of a wireless communication system due to the extra resource consumption.

Slotted mode communication methods are widely used to cut down on resource consumption where resources are scarce. In wireless technologies, slotted mode communication is used to improve battery life. However, slotted mode communication introduces processing delays since devices operating in slotted mode can only be paged for call setup during their respective slot cycles. Slot cycles, such as used in Code Division Multiple Access (CDMA) systems are generally 2.56 to 5.12 seconds long. This large amount of time is enough to cause end user dissatisfaction for time sensitive applications such as Push-To-Talk (PTT), Voice over Internet Protocol (VoIP), call setup, etc.

One technique to effect proper use of available slots for paging purposes is to add multiple paging/location areas to increase the chances of locating a mobile station in these multiple areas where an unsuccessful page in an original serving area occurs. For example, a failed page to a mobile station that was in an originally served area is followed by a global page in order to find the location where the mobile station has moved. However, such a solution is still not timely. In particular, having a first page sent to a last known paging location area with a Slot Cycle Index (SCI) of 2 takes 5.12 seconds. A first page success rate is usually eighty percent for large location areas (fifty to one hundred base transceivers) and forty to fifty percent for smaller location areas (ten to twenty base transceivers). If the first page is unsuccessful a second page is sent to all paging areas under a particular mobile switching center (MSC), where a second page is typically over ninety-five percent successful. However, even if a second page is successful, call setup can take from 6 to 11.12 seconds, including the 0 to 5.12 seconds wasted on the first page. This delay is too long, as is already recognized since such systems currently do not proceed beyond two pages. In addition, the second global paging contributes to congestion. Moreover, mobiles must re-register when crossing location area boundaries, which further adds to the congestion.

Another technique to resolve the delay issues was to introduce negative slot cycle indices. For instance, an SCI of −1 produces 640 millisecond slots, an SCI of −2 produces 320 millisecond slots, and an SCI of −4 produces 80 millisecond slots, which is essentially unslotted mode. The drawback of this technique is that mobiles wake up far too often, defeating the original purpose of slotted mode. Further, the combination of high data rates (i.e. transmit power) and a low SCI results in a very large battery drain, which is unsatisfactory.

Accordingly, a need exists to improve the paging response time and reduce congestion that does not involve expensive infrastructure improvements. It would also be of benefit to achieve such a solution that does not compromise battery life.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 is a simplified block diagram illustrating paging, in accordance with the prior art;

FIG. 2 is a simplified block diagram illustrating paging, in accordance with the present invention;

FIG. 3 illustrates a method, in accordance with the present invention.

### DETAILED DESCRIPTION OF THE PREFERRED EMBODIMENT

Generally, the present invention provides a method and apparatus which improves the paging response time and reduces congestion that does not involve expensive infrastructure improvements. The present invention also achieves such a solution without compromising battery life.

Although the present invention is described herein with respect to a Code Division Multiple Access (CDMA) system, it should be noted that the present invention is applicable to any communication system that utilizes slotted/unslotted operation modes (e.g. WiMAX, UMTS, TDMA, CDMA, OFDM, etc.).

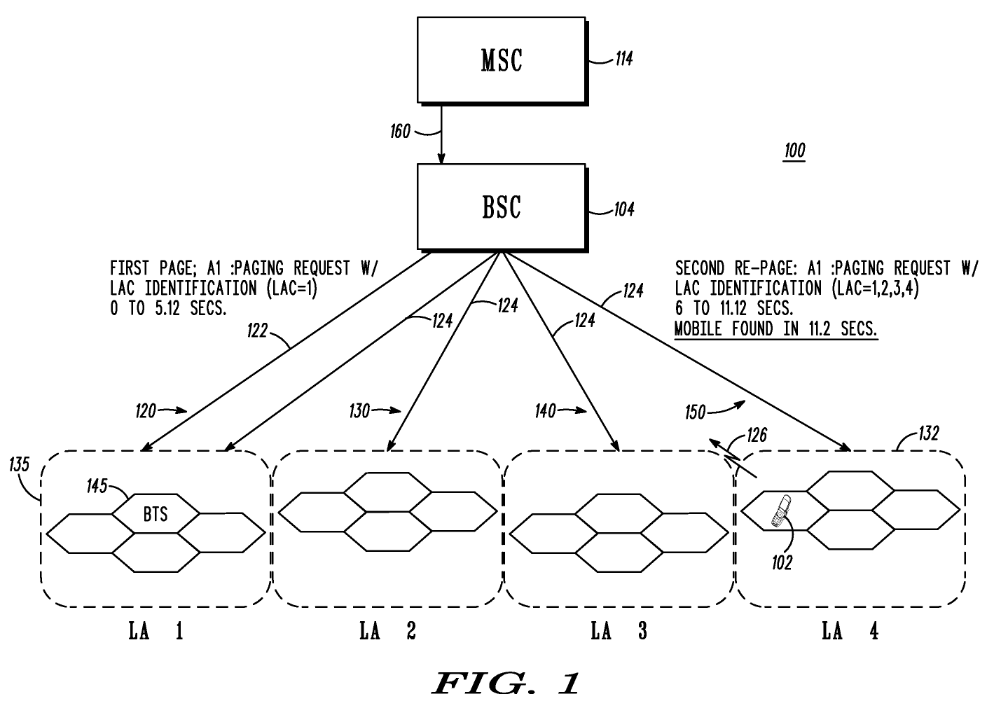

FIG. 1 representatively illustrates a wireless communication system 100 that uses a prior art technique to location a mobile station (MS) 102 that is operable to be paged in the communication system 100. The wireless communication system 100 includes a plurality network access node or base station (one BS shown) 104. As is known in the art, each BS can includes multiple base transceiver stations (BTSs) that are each coupled to a base station controller BSC (not shown). BSC 104 is coupled to a mobile switching center (MSC) 114. The MSC 114 provides a communication link between the plurality of BSC 104 and an external network or other BSs (not shown).

A portion of the plurality of base stations serves a particular paging location area (LA x) which is accessed by a location area code. As a result, all of the existing location areas are served by different subsets of the plurality of base stations. As described herein a paging location area comprises a number of cells, with each paging location area serving different sets of cells. However, it should be noted that the present invention is equally applicable to paging location areas that can also comprise a number of sectors and/or frequency carriers. A paging location area 135, such as LA 1 can include any number of cells 145. In particular, a cell 145 is a portion of paging area 135 that is served by one or more distinct BTSs of the plurality of BSC 104.

Typically, the MS 102 is operating in a slotted mode where the MS sleeps between predetermined periods and can be listening to, or in active communication with, its serving BTS during the predetermined slot periods. The MS 102 enters an idle state when it is turned on, is synchronized with wireless communication system 100, and has no calls in progress. During the idle state, the MS 102 actively listens to a paging channel for information. This information includes overhead messages, such as system parameter messages, as well as messages directly addressed to the MS 102 from one of the BSC 104.

During the idle state, one or more of the BSC 104 may communicate with the MS 102 in an unslotted or a slotted mode of a slotted cycle index (SCI). A typical paging channel slot is an 80-millisecond time slot within a paging slot cycle. The paging slot cycle ranges from 16 time slots (1.28 seconds) to 2048 time slots (163.84 seconds) depending on the SCI, although shorter time slots cycles can be attained using a negative value slot cycle index. In unslotted mode, MS 102 monitors all paging channel slots for messages from one or more of the BSC 104. In the slotted mode, the MS 102 only monitors a selected subset of the paging channel slots for messages from BSC 104. During time periods when the MS 102 is not monitoring the selected subset of paging channel slots, power is turned off in the MS RF receiver in order to conserve battery life. MS 102 may extend the battery supply operating life by entering a slotted mode of operation with its serving BTS because the MS 102 receiver consumes power only during selected slot cycles rather than across the entire paging cycle.

To explain a typical paging operation, it can first be assumed that the MS 102 is operating in slotted mode listening to one or more BSC 104 serving the paging location area 135. A paging request message 160 is sent from the MSC 114 to the BSC 104 serving the location area 135. Each paging request message 160 includes a paging area identifier in the header that identifies the last known paging location area of the MS 102. The BSC 104 associated with the identified paging area sends out a page 122 addressed to the MS 102 in the identified paging area 135. If the MS 102 has crossed paging location area boundaries to another paging location area 132, the MS 102 will not receive the page, nor will the MSC 114 know in which paging location area the MS 102 is now located. The MSC 114 will then direct BSC 104 to send a global re-page 124 to all paging location area (LA 1-4) covered by the plurality of BSC 104.

In this example, it can be assumed the MS 102 was originally operating in slotted mode, and communication with BSC 104, from LA 1. Subsequent to this original communication, MS 102 moved to LA 4, as shown, without the knowledge of BSC 104 or MSC 114 (i.e. re-registering therewith). As the MSC still believes that MS is in LA 1, MSC directs the portion of BS serving LA 1 to page 122 the MS there. Since the MS is not in LA 1 to receive the page, BS and MSC receive no response for that page. Upon this failure, and in order to locate the MS, MSC then directs the plurality of BSC 104 to perform a global re-page 124 throughout LA 1-4. The MS 102, in LA 4, receives this page and provides an acknowledgment 126. As the location of MS is now determined to be in LA 4, communication with the MS can now be performed successfully.

Due to operation in slotted mode, in this example with a slot every 5.12 seconds, the first page and second global re-page can not occur any quicker than 6 seconds (due to network overhead waiting for a response, canceling the first page, and other delays), under ideal timing conditions, and can take as much as 11.12 seconds, which is unacceptable. In addition, if the MS is outside of the boundary of paging locations areas LA 1-4, even the second global re-page would not be successful. In addition, the use of a global page over all location areas adds significantly to congestion.

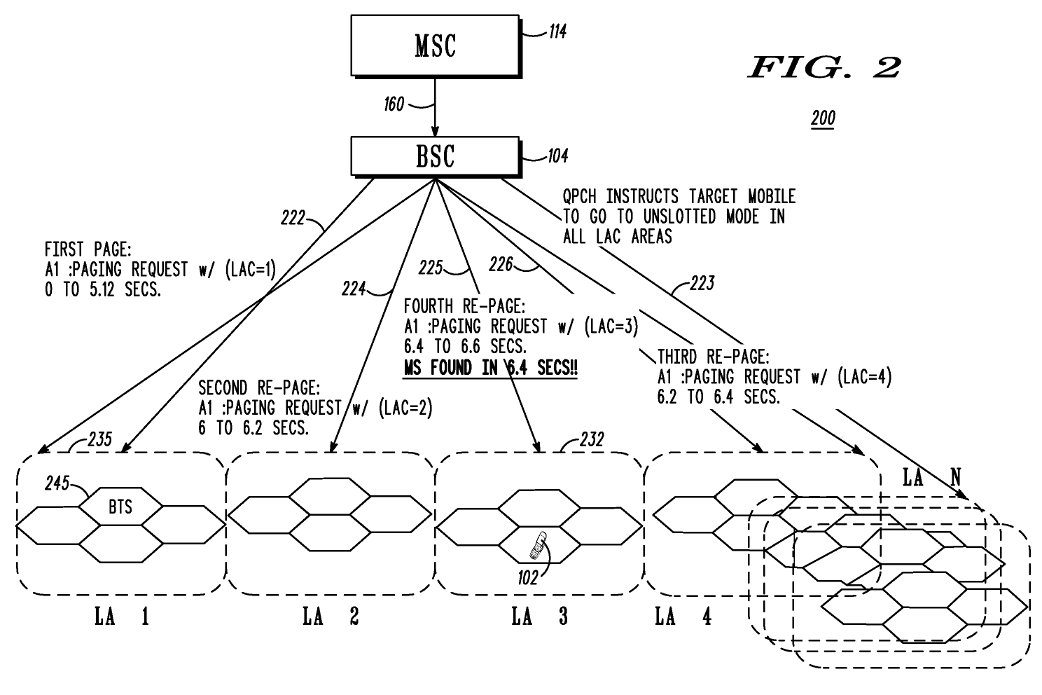

FIG. 2 representatively illustrates a wireless communication system 200 in accordance with the present invention. The wireless communication system 200 is similar to the wireless communication system 100 of FIG. 1, with a novel exception of its operation as will be detailed below. In addition, the present invention allows the use of smaller paging location areas as will be detailed below.

A plurality of base stations (BS) 104 each comprises a base station controller and a base transceiver station (not shown). Base station controllers (BSC) and base transceiver station (BTS) were described previously in connection with FIG. 1. Each BS includes processing circuitry and memory capable of executing an operating program that allows communication and control between the BSC 110 and BTS 106, and with the MSC 114. Under normal conditions, each BSC directs the operation of bi-directional communications in forward and reverse communication links between the BTS and a mobile station (MS) 102. It should be understood that this configuration is by way of illustration only and should not be construed to limit the scope of the present invention. Those skilled in the art will understand that the present invention is applicable to other embodiments in other communication systems utilizing a network access node, terminal node access controller, and the like.

The MS 102 includes and antenna, radio frequency (RF) transceiver, processor and memory, as are known in the art. The memory further comprises a basic operating system (OS) program, to control timing and to provide slotted mode control. The transceiver receives from the antenna an incoming RF signal transmitted by a BTS of wireless communication system 200 comprising a page. The transceiver down-converts the incoming RF signal to produce an intermediate frequency or a baseband signal, which is sent to processing circuitry for filtering, decoding, and/or digitizing the baseband or IF signal.

A processor further processes the page and configures the MS for communication. The processor is a microprocessor or microcontroller. Memory is coupled to processor and comprises a random access memory (RAM) and another part of memory comprises a Flash memory, which acts as a read-only memory (ROM). The processor executes a basic operating system (OS) program stored in the memory in order to control the overall operation of MS 102. In one such operation, processor controls the reception of forward link signals and the transmission of reverse link signals by radio frequency (RF) transceiver, in accordance with well-known principles.

The processor is capable of executing other processes and programs resident in memory. The processor can move data into or out of memory, as required by an executing process. The basic operating system includes a slotted mode control algorithm. When the MS 102 enters a paging location area (e.g. 135), the processor may execute the slotted mode control algorithm upon receiving instructions in paging SCI control message and thereby operate at a selected paging SCI value.

As used herein, a paging SCI value is set at a baseline value of 2, for example and without limitation. Ordinary, this would allow a paging request message 160 to be processed in a cell of a location area every 5.12 seconds by the MS 102. This baseline paging SCI value may be a maximum paging SCI value allowed by BSC 104 or MS 102 and it may change depending on any set of conditions or priorities.

Referring to FIG. 2, the present invention provides a system 200 for reducing paging response time for a target mobile station 102 operable using slotted and unslotted modes in multiple paging location areas of a wireless communication system 200. As used herein a mobile station (MS) 102 is originally operating in slotted mode, to take best advantage of the present invention. The present invention addresses a MS that moves from a last known paging location area (e.g. LA 1) and misses a message sent to that paging location area. It should be noted that the paging location areas (e.g. LA 1-4) of the present invention 200 can be reduced in size over those (e.g. LA 1-4) of the prior art 100.

A mobile switching center (MSC) 114 sends a paging request message 160 to at least one base station controller (BSC) 104 to page a target mobile station (MS) 102 in the communication system. The message includes a paging location area identifier in the header that identifies the last known paging location area (e.g. LA 1) of the MS 102. The plurality of BSC 104 under the MSC 114 receives the paging request message and sets a paging indicator for the target mobile station in response to the paging request message. In particular, a paging indicator bit is set in a Quick Paging Channel (QPCH), and is simultaneously broadcast 223 in all the paging location areas which are controlled by a plurality of base stations under control of the MSC. In this way, the MS, even if it has moved from its last known paging location area, will most likely receive the paging indicator and prepare for the incoming page. In practice, the broadcasting step 223 occurs approximately 100 milliseconds before a next slot cycle of the target mobile station for best response, but should in any case occur in a time period preceding a next slot cycle of the target mobile station. A target mobile station 102 operates in an unslotted mode upon recognition of the paging indicator bit. In this example, the mobile station 102 is paging location area 232 (LA 3) when it recognizes the broadcast paging indicator and switches to unslotted mode. Being in unslotted mode allows the mobile station to quickly detect any paging message directed thereto.

A portion of a plurality of base transceiver stations serving a last known paging location area (e.g. LA 1) of the target mobile station receive the paging request message and page the target mobile station in a last known location area. Those BTSs not serving the identified last known paging location area (e.g. LA 1) ignore the paging request message.

If the target mobile station is still in LA 1 it would acknowledge the page, and switch operation to slotted mode again upon successful receipt of the page and processing of the incoming call between the MSC and mobile station. However in this example, MS 102 is no longer in the indicated paging location area 235 (i.e. LA 1), and has crossed boundaries to paging location area 232 (i.e. LA 3). As a result, MS 102 does not receive or acknowledge the first page 222 even though it knows that a page is due. The MS (102), on receiving the paging indicator bit, will remain unslotted for a period of time that is longer than a typical time for receiving a page irrespective of whether it receives a page message in the current paging slot or not.

When the MSC 114 does not receive any acknowledgement of its paging request message (i.e. the portion of bases transceiver stations fail to establish contact with the target mobile station in the last known paging location), the MSC 114 can re-page to the MS 102 in at least one other selected location area without waiting for the start of the next slot cycle. This is possible because the mobile station (102) is already anticipating the arrival of pages given that it was alerted to incoming pages by the paging indicator bit that was enabled prior to the start of the paging slot.

The BTSs for different location areas are directed to sequentially re-page the target mobile station in each of at least one different selected location area (e.g. LA 2, LA 3 . . . LA N). This can go on until the mobile station is found, whereupon the MS will acknowledged the page, thereby giving its present paging location area as LA 3, and switch operation to slotted mode again upon successful receipt of the page and processing of the call between the MSC and mobile station. Optionally, the mobile station can wait to receive a page until the expiration of a timer, indicating that paging of the target mobile station has been unsuccessful, and the target mobile station can switch operation to slotted mode again.

Since the paging slots are synchronized across the communication system, the paging indicator can be turned on in all paging location areas before waiting to get a page response from the last known location. By doing this, the mobile station can be re-paged in the other location areas before the next instance of the paging slot cycle which might be 5.12 seconds away. Due to operation in unslotted mode, in this example with a slot every 80 milliseconds after the 5.12 seconds of the first page 222, the second re-page 224 in LA 2 can occur in a time period of only 6 to 6.2 seconds (the additional time due to network overhead waiting for a response, canceling the first page, and other delays), the third re-page 226 in LA 4 can occur in a time period of only 6.2 to 6.4 seconds, and the third re-page 225 in LA 3 can occur in a time period of only 6.4 to 6.6 seconds before finding the mobile station 102, which is more acceptable than the prior art system 100 which found the mobile station in 11.12 seconds. In addition, the present invention can search about twenty different location area in the same time it took the prior art to just do the second global re-page.

Further, in order to improve the paging location accuracy and reduce the time for a successful page, the different location areas for subsequent re-paging are selected according to a predetermined search algorithm, such as a Bayesian search algorithm for example. In a Bayesian search multiple known inputs (last known location, user mobility patterns, user speed, etc.) can be combined coherently to produce an overall probability distribution. This allows searching for the user starting over high probability areas, then intermediate probabilities, then the low probability areas. In addition, by using smaller location areas with the expanding search area algorithms, the present invention reduces the likelihood of congestion in unaffected areas by targeting the mobile station more effectively. Further, the use of the QPCH in accordance with the present invention wakes up all mobiles which expands register area so it is not necessary to re-register mobiles.

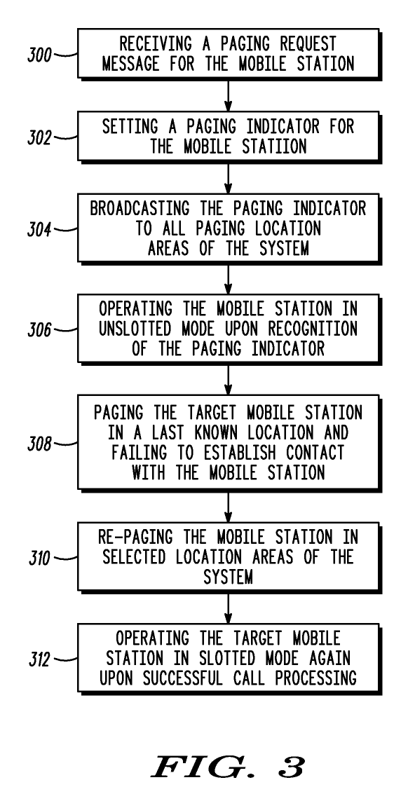

FIG. 3 representatively illustrates a logic flow diagram in accordance with an exemplary embodiment of a method of reducing paging response time in a wireless communication system for a target mobile station operable using slotted and unslotted modes in multiple paging location areas of the communication system, in accordance with the present invention.

The method includes a first step 300 receiving a paging request message for the target mobile station operating in slotted mode.

A next step 302 includes simultaneously setting a paging indicator for the target mobile station. In particular, a paging indicator bit is set in a Quick Paging Channel (QPCH) for the target mobile station.

A next step 304 includes simultaneously broadcasting the paging indicator to all paging location areas of the communication system. In particular, this step includes broadcasting the paging indicator bit in the QPCH. In practice, the broadcasting step occurs approximately 100 milliseconds before a next slot cycle of the target mobile station for best response, but should in any case occur in a time period preceding a next slot cycle of the target mobile station.

A next step 306 includes operating the target mobile station in an unslotted mode upon recognition of the paging indicator by the target mobile station and acknowledges the page, thereby giving its present paging location area (e.g. LA 3).

A next step 308 includes paging the target mobile station in a last known location and failing to establish contact with the mobile station.

A next step 310 includes re-paging the target mobile station in at least one different location area for each subsequent paging frame of the unslotted mode if receipt of the page by the target mobile station is unsuccessful. The different location areas for repeated paging are selected according to a predetermined search algorithm, such as a Bayesian search algorithm for example.

A next step 312 includes operating the target mobile station in slotted mode again upon successful receipt of the page by the target mobile station and processing of a call associated with the paging request message. Optionally, this step can include operating the target mobile station in slotted mode again upon expiration of a timer if receipt of the page by the target mobile station is unsuccessful.

Advantageously, the present invention provides a technique to improve mobile location and paging delays while reducing congestion. This is achieved, a) without compromising slotted mode methods used for conserving resource usage, b) without any impact to RF capacity (i.e. multiple paging channels and/or additional common control channels), c) without adding operating expenses or more carriers for network operators, and d) without introducing complex features to the network.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method of reducing paging response time in a wireless communication system for a target mobile station operable using slotted and unslotted modes in multiple paging location areas of the communication system, the method comprising the steps of:
receiving a paging request message for the target mobile station operating in slotted mode;
setting a paging indicator for the target mobile station;
broadcasting the paging indicator to all paging location areas of the communication system;
operating the target mobile station in an unslotted mode upon recognition of the paging indicator by the target mobile station;
paging the target mobile station in a last known location and failing to establish contact with the mobile station;
re-paging the target mobile station in at least one selected location area of the system; and
operating the target mobile station in slotted mode again upon successful receipt of the page by the target mobile station and processing of a call associated with the paging request message.

2. The method of claim 1, wherein the operating in slotted mode step includes operating the target mobile station in slotted mode again upon expiration of a timer if receipt of the page by the target mobile station is unsuccessful.

3. The method of claim 1, wherein the setting step includes setting a paging indicator bit in a Quick Paging Channel (QPCH) for the target mobile station, and wherein the broadcasting step includes broadcasting the paging indicator bit in the QPCH.

4. The method of claim 1, wherein the broadcasting step occurs in a time period preceding a next slot cycle of the target mobile station.

5. The method of claim 4, wherein the broadcasting step occurs approximately 100 milliseconds before a next slot cycle of the target mobile station.

6. The method of claim 1, wherein the re-paging step includes re-paging the target mobile station in at least one different location area for each subsequent paging frame of the unslotted mode if receipt of the page by the target mobile station is unsuccessful.

7. The method of claim 6, wherein the different location areas for re-paging are selected according to a predetermined search algorithm.

8. A method of reducing paging response time in a wireless communication system for a target mobile station operable using slotted and unslotted modes in multiple paging location areas of the communication system, the method comprising the steps of:
receiving a paging request message for the target mobile station operating in slotted mode;
setting a paging indicator for the target mobile station;
broadcasting the paging indicator to all paging location areas of the communication system in a time period preceding a next slot cycle of the target mobile station;
operating the target mobile station in an unslotted mode upon recognition of the paging indicator by the target mobile station;
paging the target mobile station in a last known location and failing to establish contact with the mobile station;
re-paging the target mobile station in at least one different selected location area for each subsequent paging frame of the unslotted mode; and
operating the target mobile station in slotted mode again upon successful receipt of the page by the target mobile station and processing of a call associated with the paging request message.

9. The method of claim 8, wherein the operating in slotted mode step includes operating the target mobile station in slotted mode again upon expiration of a timer if receipt of the page by the target mobile station is unsuccessful.

10. The method of claim 8, wherein the setting step includes setting a paging indicator bit in a Quick Paging Channel (QPCH) for the target mobile station, and wherein the broadcasting step includes broadcasting the paging indicator bit in the QPCH.

11. The method of claim 8, wherein the different location areas in the re-paging substep are selected according to a Bayesian search algorithm.

12. A system for reducing paging response time for a target mobile station operable using slotted and unslotted modes in multiple paging location areas of a wireless communication system, the system comprising:
a mobile switching center (MSC) operable to send a paging request message for the target mobile station that is operating in slotted mode;
at least one base station controller (BSC) coupled to the MSC, the at least one BSC operable to set a paging indicator for the target mobile station and broadcast the paging indicator to all paging location areas of the communication system;
a target mobile station that operates in an unslotted mode upon recognition of the paging indicator;
a portion of a plurality of base transceiver stations serving a last known paging location of the target mobile station operable to receive the paging request message, the base transceiver stations operable to page the target mobile station in a last known location, wherein
if the portion of bases transceiver stations fail to establish contact with the target mobile station in the last known paging location, the MSC operates to re-page the target mobile station in at least one selected location area of the communication system; and
the target mobile station is operable to switch a slotted mode of operation again upon successful receipt of the page and processing of the call between the MSC and mobile station.

13. The system of claim 12, wherein the target mobile station is operable to switch to slotted mode again upon expiration of a timer if receipt of a page by the target mobile station is unsuccessful.

14. The system of claim 12, wherein the paging indicator is a paging indicator bit in a Quick Paging Channel (QPCH) for the target mobile station, and wherein the plurality of base stations broadcast the paging indicator bit in the QPCH.

15. The system of claim 12, wherein the plurality of base stations is operable to broadcast the paging indicator in a time period preceding a next slot cycle of the target mobile station.

16. The system of claim 15, wherein the plurality of base stations are operable to broadcast the paging indicator approximately 100 milliseconds before a next slot cycle of the target mobile station.

17. The system of claim 12, wherein if a paging is unsuccessful, the MSC can direct select base station transceivers to re-page the target mobile station in at least one different location area for each subsequent paging frame of the unslotted mode.

18. The system of claim 17, wherein the different location areas for re-paging are selected according to a search algorithm.

19. The system of claim 18, wherein the different location areas for re-paging are selected according to a Bayesian search algorithm.
